(19) United States
(12) Patent Application Publication
(10) Pub. No.: US 2005/0280169 A1
(43) Pub. Date: Dec. 22, 2005

(54) Gas-liquid contact tray with fixed valves for mass transfer

(75) Inventors: Kejian Yao, Hangzhou (CN); Lianghua Wang, Hangzhou (CN); Xiaomei Yu, Hangzhou (CN)

Correspondence Address: LADAS & PARRY, 26 WEST 61ST STREET, NEW YORK, NY, 10023, US

(73) Assignees: CHINA PETROLEUM & CHEMICAL CORPORATION; ZHEJIANG UNIVERSITY OF TECHNOLOGY

(21) Appl. No.: 10/872,792

(22) Filed: Jun. 21, 2004

(51) Int. Cl. B01F 3/04

(52) U.S. Cl. 261/114.3; 261/114.5

(57) ABSTRACT

A gas-liquid contact tray with fixed valves for mass transfer, in which the fixed valve comprising an upstream portion, a midportion and a downstream portion is made by punch from the tray deck so as to form as a deflector, and the upstream portion and the downstream portion are integrated with the tray deck, characterized in that said midportion has a central plane portion and downward inclined margins, and the tray deck is further provided with perforations which are arranged between the fixed valves adjacent in the liquid flow direction. The gas-liquid contact tray with fixed valves for mass transfer according to the present invention has a low liquid entrainment, low liquid weeping, a high mass transfer capacity and good turn-down characteristics.

### FIELD OF THE INVENTION

The present invention relates to a gas-liquid contact tray with fixed valves for mass transfer. The tray is used for the fractional distillation columns, the absorption columns, or the adsorption columns in the oil refining industry, the chemistry industry, the petrochemistry industry, the light industry, or the like.

### PRIOR ART

Before the present invention, there have been developed the tray with perforations, the tray with floating valves, and the tray with fixed valves.

The tray with perforations has advantages of low pressure drop, few choke, easy making, low cost, and no maintenance, but also has disadvantages of too much liquid entrainment, too much liquid weeping, low processing capacity and low mass transfer efficiency.

The tray with floating valves overcome the disadvantages of the tray with perforations, has advantages of high processing capacity, low liquid entrainment, low liquid weeping, and high mass transfer efficiency, but also has disadvantages of too much necessary raw materials, high manufacturing cost, easy choke, low working reliability.

U.S. Pat. No. 5,360,583, U.S. Pat. No. 5,147,584, and U.S. Pat. No. 5,975,504 disclose a tray with fixed valves, whose manufacturing cost is as low as the tray with perforations, and whose performing function is as well as the tray with floating valves, and whose strength is stronger than the tray with perforations and the tray with floating valves. Unfortunately, in these patents, the gas flow or jet is horizontally blew off from the side openings of each fixed valve and then is blew into the liquid layer, forming a face-to-face impinging flow between any two adjacent fixed valves with the gas being blew off from the side opening of another fixed valve (see FIG. 15). The jet 28 is forced to pass through the fixed valve aperture 46 in an upward direction, then is obstructed from the flat fixed valve top surface (or called midportion) 37 and the fixed valve legs (or called upstream and downstream portions) 25, 26, so is forced to change its flow direction, i.e., is horizontally ejected from the fixed valve side opening 42 along the tray deck, resulting in a face-to-face impinging between any two adjacent fixed valves 17 with the jet 28 being blew out from the side opening 42 of another adjacent fixed valve, thus causing a whirlpool 52 in the two adjacent fixed valves 17. The impinging jets 28 not only cause the liquid splash upward from the tray deck, thus forming more liquid entrainment and lowering the mass transfer capacity, but also consume more energy and increase the pressure drop of the tray

### SUMMARY OF THE INVENTION

Thus, one object of the present invention is to provide a gas-liquid contact tray with fixed valves for mass transfer, which has a low liquid entrainment and low liquid weeping.

Another object of the present invention is to provide a gas-liquid contact tray with fixed valves for mass transfer, which has a high mass transfer capacity and good turn-down characteristics.

Another object of the present invention is to provide a gas-liquid contact tray with fixed valves for mass transfer, which has a simple structure and a low cost.

Another object of the present invention is to provide a gas-liquid contact tray with fixed valves for mass transfer, which has an improved liquid distribution in the side bubbling segments near the column wall.

Another object of the present invention is to provide a gas-liquid contact tray with fixed valves for mass transfer, which has an improved liquid distribution on the tray deck, so as to prevent from any whirlpool being formed between any two adjacent fixed valves, thus increasing the mass transfer efficiency.

In order to realize above mentioned objects, according to the first aspect of the present invention, there is provided a gas-liquid contact tray with fixed valves for mass transfer, in which the fixed valve comprising an upstream portion, a midportion and a downstream portion is made by punch from the tray deck so as to form as a deflector, and the upstream portion and the downstream portion are integrated with the tray deck, characterized in that said midportion has a central plane portion and downward inclined margins.

According to the second aspect of the present invention, there is provided a gas-liquid contact tray with fixed valves for mass transfer, in which the fixed valve comprising an upstream portion, a midportion and a downstream portion is made by punch from the tray deck so as to form as a deflector, and the upstream portion and the downstream portion are integrated with the tray deck, characterized in that said midportion is of an up-side-down V shape or an arc shape.

According to the third aspect of the present invention, there is provided a gas-liquid contact tray with fixed valves for mass transfer, the upstream portion and the downstream portion of the fixed valve are integrated with the tray deck, characterized in that the tray deck, the upstream portion and the downstream portion enclosed only one opening on one side of the fixed valves, and the opening is of an up-side-down V shape, an arc shape, or a trapezoid shape.

According to the fourth aspect of the present invention, there is provided a gas-liquid contact tray with fixed valves for mass transfer, in which the fixed valve comprising an upstream portion and a downstream portion is made by punch from the tray deck, and the upstream portion and the downstream portion are integrated with the tray deck, characterized in that the tray deck is further provided with perforations which are arranged between the fixed valves adjacent in the liquid flow direction.

According to the fifth aspect of the present invention, there is provided a gas-liquid contact tray with fixed valves for mass transfer, in which the fixed valve comprising an upstream portion and a downstream portion is made by punch from the tray deck, and the upstream portion and the downstream portion are integrated with the tray deck, characterized in that said fixed valves include the fixed valves with openings on both sides, and/or the fixed valves with an opening on only one side.

According to the sixth aspect of the present invention, there is provided a gas-liquid contact tray with fixed valves for mass transfer, in which the fixed valve comprising an upstream portion, a midportion and a downstream portion is made by punch from the tray deck so as to form as a deflector, and the upstream portion and the downstream portion are integrated with the tray deck, characterized in that said midportion has a central plane portion and downward inclined margins, and the tray deck is further provided with perforations which are arranged between the fixed valves adjacent in the liquid flow direction.

Preferably, in the two side bubbling segments, the fixed valves with openings on both sides are arranged along the radii, and the longitudinal centerline of the fixed valves with openings on both sides is perpendicular to the radii of the tower.

Preferably, in the two side bubbling segments, near the wall of the tower, there are provided with the fixed valves with an opening on only one side, and the opening of the fixed valves with an opening on only one side is parallel to the radii of the tower.

Preferably, said perforations are of a rectangle, trapezoid, circular, oval, square, triangle, or polygon shape.

Preferably, said perforations are through holes and/or partial blind holes.

Preferably, said central plane portion is shaped as rectangle, trapezoid, circular, oval, square, triangle, or polygon.

Preferably, the width of the upstream portion is equal to or greater than that of the downstream portion.

According to the present invention, the fixed valves with openings on both sides are directly formed by a punch process so as to be deflected from the tray deck as deflectors, therefore, the gas-liquid contact tray with fixed valves according to the present invention has a simple structure and a low cost. As no additional raw materials are necessary, the manufacturing cost is further lowered.

Moreover, after the fixed valves are formed by punch process from the raw tray material, the tray becomes a three dimensional body from a plate, so the tray deck becomes stronger in strength, therefore, even if the inner raw material is used, a strong enough tray deck is still available according to the present invention, thus less material is required and the cost is further lowered.

Preferably, the fixed valves with openings on both sides have eaves, therefore, whenever the jet is forced to pass through the aperture of the fixed valve in a upward direction, it obstructed from the midportion of the fixed valve, the eave deflected downward, as well as the upstream and downstream portions, so that the jet is automatically changed its flow direction and is blew out from the side opening of the fixed valve and deflected toward to the tray deck, thus the jet is blew onto the tray deck at first and then goes up, so as to prevent from the face-to-face impinging occurred in prior art between any two adjacent fixed valves, therefore, the liquid entrainment is minimized.

Thanks to the present invention, the fixed valves with openings on both sides have eaves, therefore, the jet blew out from the side opening of the fixed valve is further blew into the bubbling liquid in a downward inclined direction, so as to prevent from the jet blew out from one side opening of a fixed valve going into the side opening of another adjacent fixed valve, therefore, the liquid weeping is also minimized.

Preferably, the jet blew out from the side opening of the fixed valve is further blew into the bubbling liquid in a downward inclined direction at first and then goes up, so as to prevent from big bubble occurring, so that the bubbles occurring on the tray deck becomes more uniform, the gas-liquid contact area is increased, and the gas-liquid mass transfer becomes more effective. Therefore, by using the fixed valves with openings on both sides have eaves, the liquid entrainment is minimized and the liquid weeping is also minimized. Thus, mass transfer capacity is increased and turn-down characteristics becomes better.

In addition, according to the fixed valves with an opening on only one side, after the jet is forced to pass through the aperture of the fixed valve in an upward direction, it obstructed from the cover of the fixed valve, and the jet is automatically changed its flow direction and is blew out from the single side opening of the fixed valve, so that the going forward jet can lead the liquid to flow in the direction of the jet, so as to improve the distribution of the liquid flow on the tray deck.

Preferably, in the central bubbling segment on the tray deck according to the present invention, the fixed valves with openings on both sides are arranged in a row-to-row manner. Each row of the fixed valves with openings on both sides is parallel to the weir of the downcorner. One row of the fixed valves with openings on both sides is staggered from another adjacent row of the fixed valves with openings on both sides, so that a fixed valve in one row is in a midway between two adjacent fixed valves in another adjacent row. The longitudinal centerline of the fixed valves with openings on both sides is perpendicular to the weir of the downcorner. In this case, the liquid falling down through the upper tray deck downcorner is received by the liquid receiving segment of the lower tray deck, then flow toward the downcorner on the downstream of the lower tray deck, thus the liquid flow moves forward with an uniform speed and goes through the center bubbling segment, while performs gas-liquid mass transfer with the jet ejected from the side openings of the fixed valves.

Moreover, whenever the liquid flow from the liquid receiving segment toward the downcorner after falling down through the upper tray deck downcorner onto the liquid receiving segment of the lower tray deck, as there are two side bubbling segments, the cross-section of the liquid flow become bigger and bigger, and then smaller and smaller. Therefore, the liquid flow tends to flow faster in the central bubbling segment than in the side bubbling segments, so that it is possible to create the undesired whirlpool in the side bubbling segments.

Thanks to the present invention, in the two side bubbling segments, the fixed valves with openings on both sides are arranged along the radii. The longitudinal centerline of the fixed valves with openings on both sides is perpendicular to the radii of the tower. Therefore, even if in the two side bubbling segments, the fixed valves with openings on both sides can guide the liquid flow in the two side bubbling segments to move forward with a uniform speed and go through the bubbling area of the tray deck.

According to the present invention, near the wall of the tower, some fixed valves with openings on both sides can be replaced with the fixed valves with an opening on only one side, and the opening of the fixed valves with an opening on only one side is parallel to the radius of the tower. Therefore, the jet is prevented from leading the liquid to bump onto the wall of the tower and then rebound from the wall and enter the side openings of the fixed valves, thus the liquid weeping is also prevented.

Preferably, the opening of the fixed valves with an opening on only one side is parallel to the radius of the tower, so as to guide the liquid flow to move forward in the jet direction, and to lead the liquid flow near the wall of the tower to minimize its stagnant there.

Therefore, in the tray deck according to the present invention, the fixed valves with openings on both sides and the fixed valves with an opening on only one side are arranged in a manner to guide the liquid flow to move forward with a uniform speed and go through the tray deck, so that the working efficiency of the tray deck is increased.

According to the present invention, perforations can be arranged between two fixed valves with openings on both sides, between two fixed valves with an opening on only one side, or between one fixed valve with openings on both sides and one fixed valve with an opening on only one side, and the jet also upwardly goes through the perforations and enters the bubbling liquid on the tray deck, so as to destroy any whirlpool possibly existed in the two adjacent fixed valves, so that the bubbles occurring on the tray deck becomes more uniform, the gas-liquid contact area is increased, and the working efficiency of the tray deck is increased. In addition, as more apertures and perforations are provided on the tray deck, the mass transfer capacity is also increased.

### BRIEF DESCRIPTION OF THE ACCOMPANYING DRAWINGS

FIG. 1 shows the basic environment of cross-flow trays constructed according to the present invention.

FIG. 2 shows the cross-section of tower along A-A line, which indicates the proportions of a typical tray.

FIG. 3 shows the layout of the fixed valves of the tray deck.

FIGS. 4A and 4B show an up-side-down V shaped fixed valve.

FIGS. 5A and 5B show an arc shaped fixed valve.

FIGS. 6A and 6B show a trapezoid shaped fixed valve.

FIGS. 7A and 7B show a fixed valve with a trapezoid midportion.

FIGS. 8A and 8B show a fixed valve with a circular midportion

FIGS. 9A-9D show perforations of different shapes.

FIG. 10 shows an up-side-down V shaped fixed valve with an opening on only one side.

FIG. 11 shows an arc shaped fixed valve with an opening on only one side.

FIG. 12 shows a trapezoid shaped fixed valve with an opening on only one side.

FIG. 13A shows another possible up-side-down V shaped fixed valve.

FIG. 13B shows another possible arc shaped fixed valve.

FIG. 14 illustrates the gas-liquid contact process on the tray deck according to the present invention.

FIG. 15 illustrates the gas-liquid contact process on the tray deck according to the prior art.

### DETAILED DESCRIPTION OF THE PREFERRED EMBODIMENTS

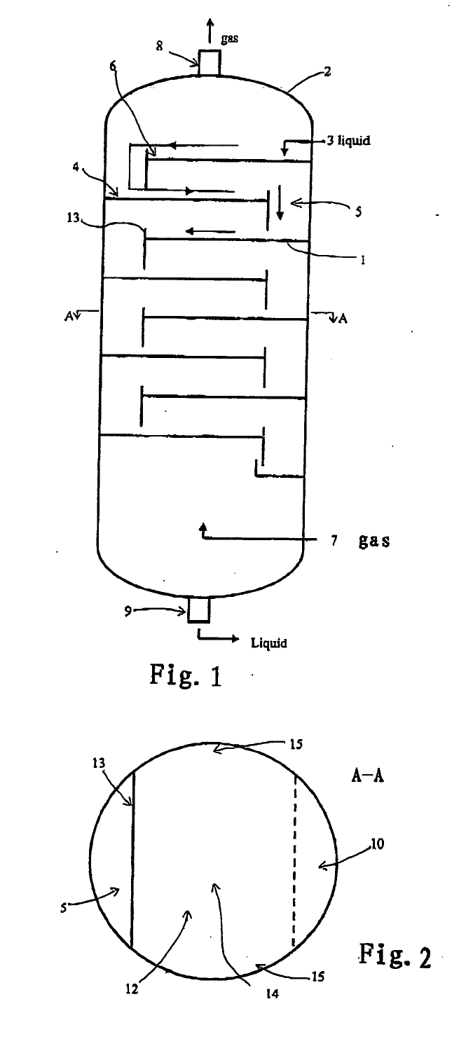

FIG. 1 schematically shows the basic environment of cross-flow trays constructed according to the present invention, in which a plurality of horizontal trays 1 are mounted in a vertical tower 2 and are vertically spaced from each other. Liquid is fed to the upstream end 4 of the uppermost tray by a liquid supply line 3. Down-corner passages 5 (downcorner called thereafter) lead the liquid from the downstream end 6 of an upper tray to the upstream end 4 of the next lower tray. Gas is introduced into the lower end of the tower by a gas supply line 7. The gas will ascend through the tower, passing up the bubbling elements (i.e. the fixed valves and perforations as defined thereafter) of the tray and going into the liquid on the trays. The tower has a vapor outlet 8 at its upper end, and a liquid outlet 9 at its lower end.

The tray with fixed valves according to the present invention is to increase mass transfer efficiency and increase processing capacity. The proportions of a typical tray are shown in FIG. 2. Each tray has an unperforated upstream segment 10 which receives liquid from a downcorner 5 and redirects the liquid flow to a bubbling area 12 where the bubbling elements 11 are located. The liquid flow passes through the bubbling area 12, while contacts and performs the mass transfer with the gas entered the liquid flow via the bubbling elements 11, then the liquid flow passes over a weir 13, goes into the next downcorner 5 for the next lower tray, and reaches the next lower tray. The bubbling area 12 includes a central bubbling segment 14 and two side bubbling segments 15.

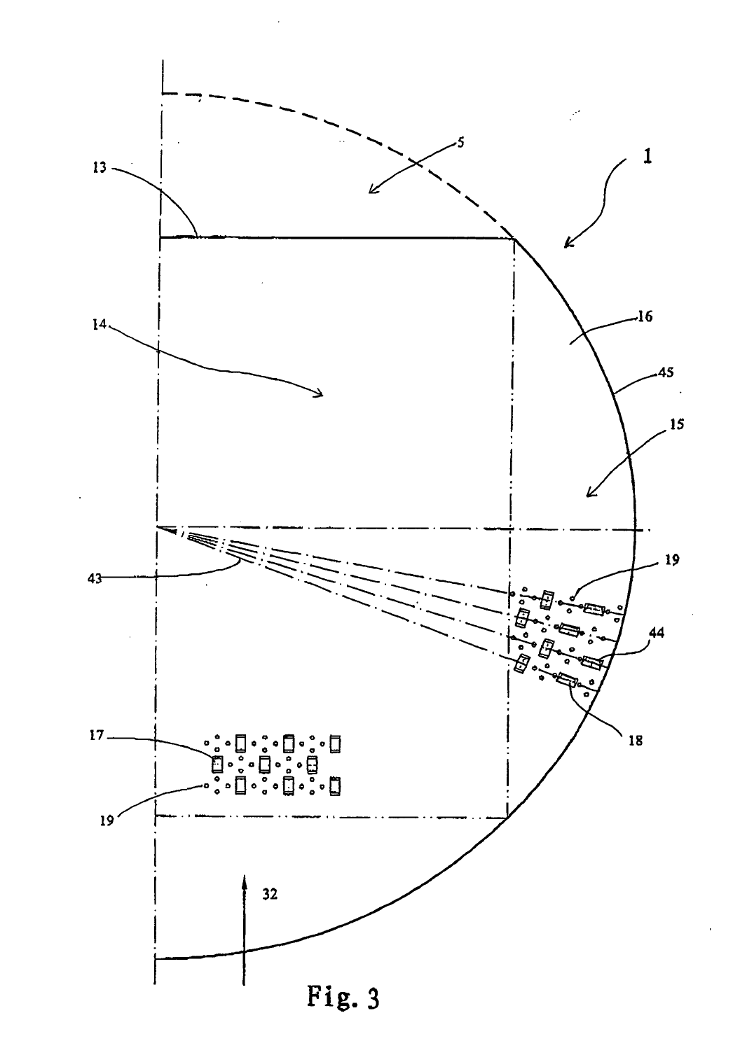

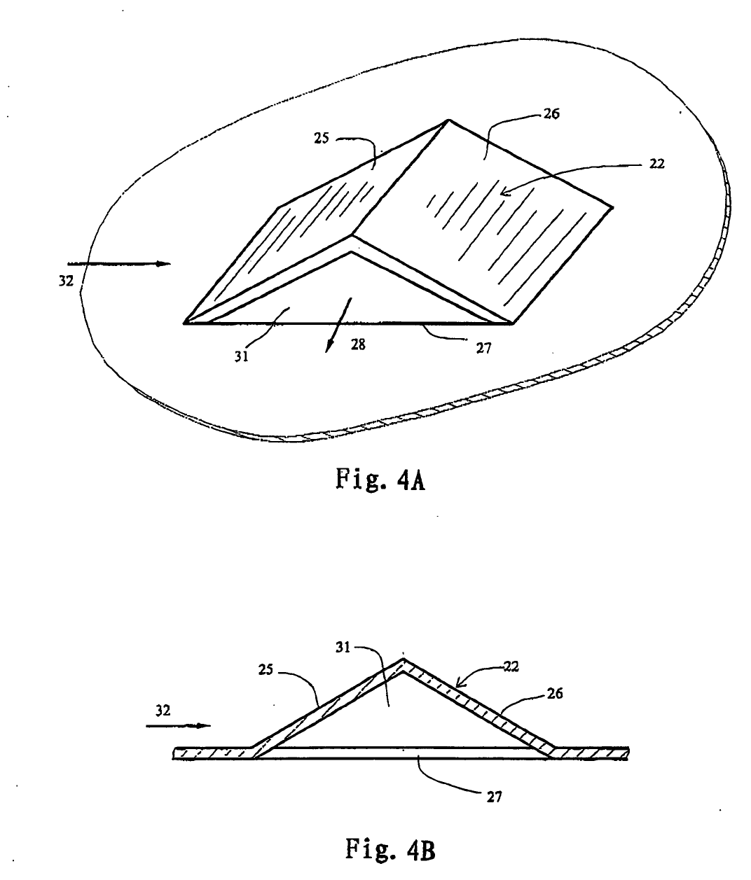

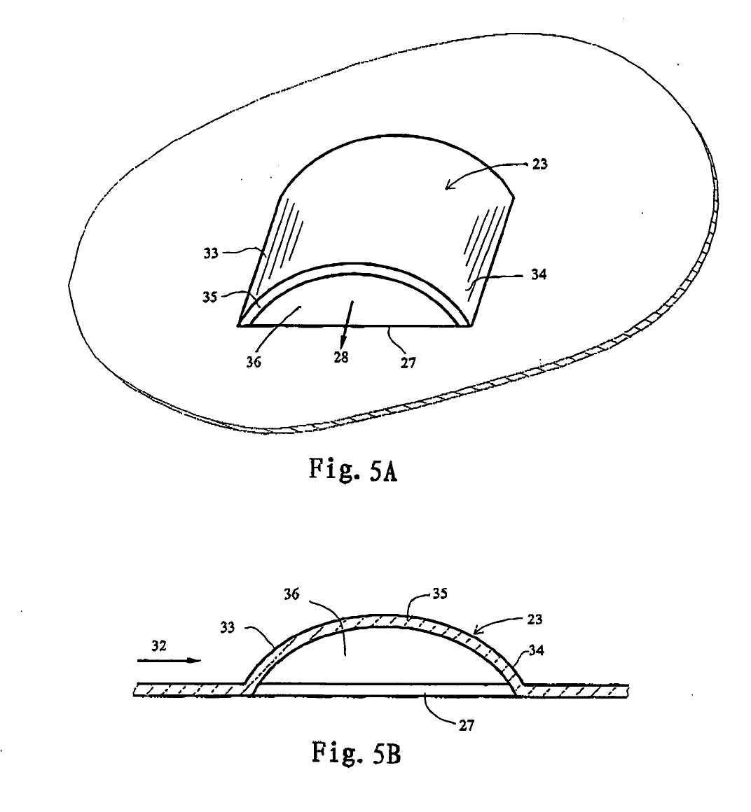

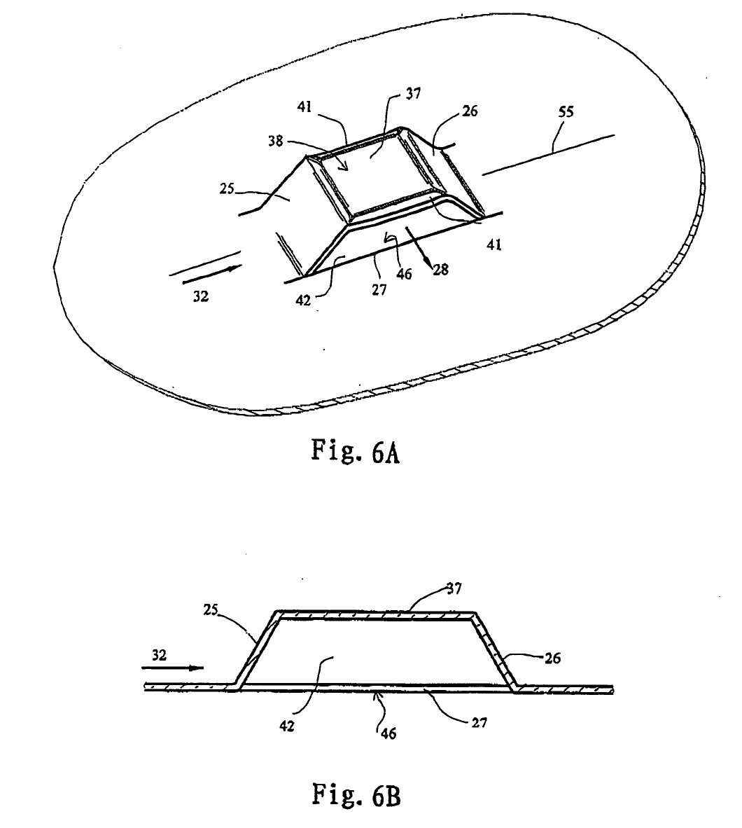

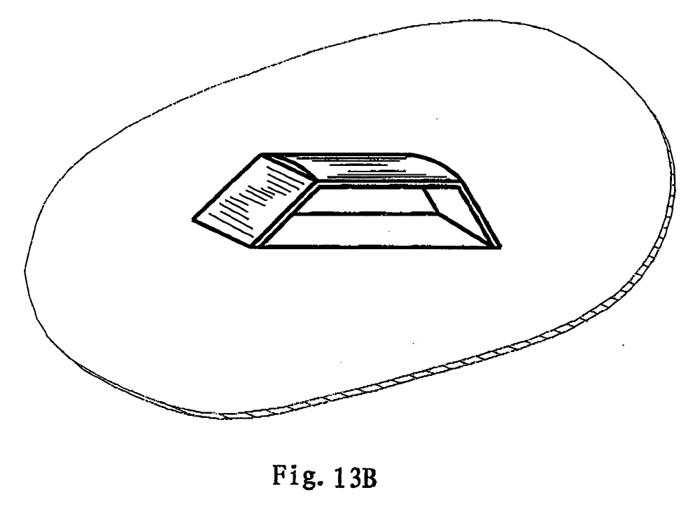

According to one embodiment of the present invention, as shown in FIG. 3, a tray 1 has a tray deck 16, a plurality of fixed valves 17 each of which has one opening on one side and another opening on the another side, and/or a plurality of fixed valves 18 each of which has a single hole on only one side, and/or a plurality of perforations 19. In the direction of the liquid flow, on the downstream end of the tray with fixed valves, there is located the so called downcorner 5. The fixed valve with two side openings can be made by punch from the tray deck 16. The two longitudinal ends of the fixed valve are integrated with the tray deck 16. The fixed valve with two side openings can be symmetrical with respect to its centerlines. According to the shape of its cross-section or longitudinal section, the fixed valve with two side openings 17 can be of an up-side-down V shaped fixed valve 22 (see FIGS. 4A and 4B, 13A), arc shaped fixed valve 23 (see FIGS. 5A and 5B, 13B), and trapezoid shaped fixed valve 24 (see FIGS. 6A and 6B).

In one embodiment of the present invention, as shown in FIGS. 4A and 4B, an up-side-down V shaped fixed valve 22 has an upstream portion 25 and a downstream portion 26. The upstream portion 25 and the downstream portion 26 are integrated with the tray deck 16. The width of the upstream portion 25 is equal to or greater than that of the downstream portion 26. The jet 28 is ejected from the triangle side opening 31 enclosed by the upstream portion 25, the downstream portion 26, and the edge 27 of the aperture on the tray deck. The liquid flow 32 delivered from the upstream of tray performs the gas-liquid contact on the tray deck, so as to perform mass transfer and heat transfer.

In one embodiment of the arc shaped fixed valve 23, as shown in FIGS. 5A and 5B, the two ends of the arc shaped fixed valve 23 are integrated with the tray deck 16. The width of the upstream portion 33 is equal to or greater than that of the downstream portion 34. The jet 28 is ejected from the arc-chord shaped side opening 36 enclosed by the edge 35 of the arc shaped fixed valve 23 and the edge 27 of the aperture on the tray deck. The liquid flow 32 delivered from the upstream of tray performs the gas-liquid contact on the tray deck, so as to perform mass transfer and heat transfer.

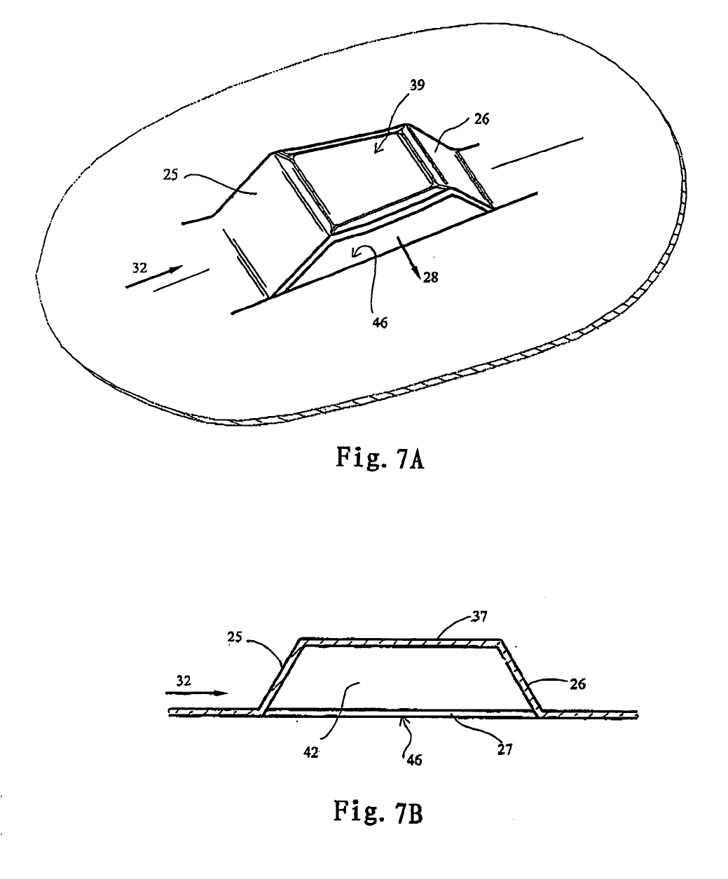

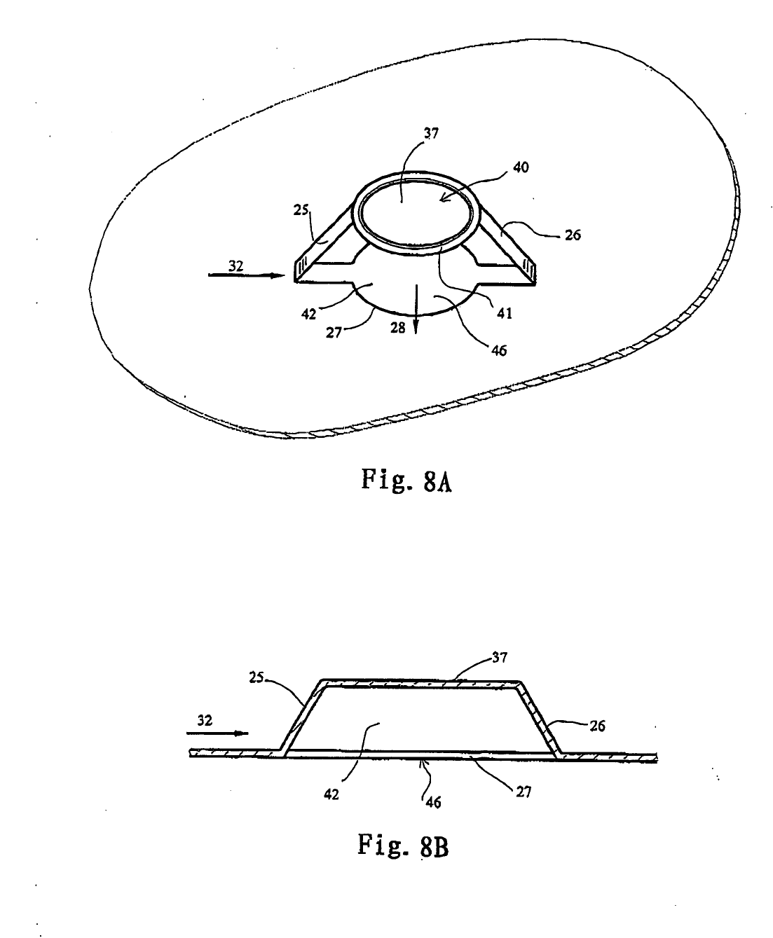

In one embodiment of the trapezoid shaped fixed valve 24, as shown in FIGS. 6A and 6B, a trapezoid shaped fixed valve 24 has an upstream portion 25, a midportion 37, and a downstream portion 26. The midportion 37 has eaves 41 deflected downward and overhang at the two longitudinal side edges of the midportion 37 respectively. According to the shape of midportion 37, the fixed valve may be the fixed valve with a rectangular midportion, the fixed valve with a trapezoid midportion (see FIGS. 7A and 7B), the fixed valve with a circular midportion (see FIGS. 8A and 8B), etc. The jet 28 is ejected from the trapezoid side opening 42 enclosed by the upstream portion 25, the downstream portion 26, the eave 41, and the edge 27 of the aperture on the tray deck. The liquid flow 32 delivered from the upstream of tray performs the gas-liquid contact on the tray deck, so as to perform mass transfer and heat transfer.

Moreover, for the fixed valve 38 with a rectangular midportion, the shape of the midportion 37 is a rectangle, the width of the upstream portion 25 is equal to that of the downstream portion 26. For the fixed valve 39 with a trapezoid midportion, the shape of the midportion 37 is a trapezoid, the width of the upstream portion 25 is greater than that of the downstream portion 26. For the fixed valve 40 with a circular midportion, the shape of the midportion 37 is a disk, the width of the upstream portion 25 is equal to or greater than that of the downstream portion 26.

Further, the midportion 37 of the fixed valve can also be a shape of oval, triangle, square, polygon or any other desired shape.

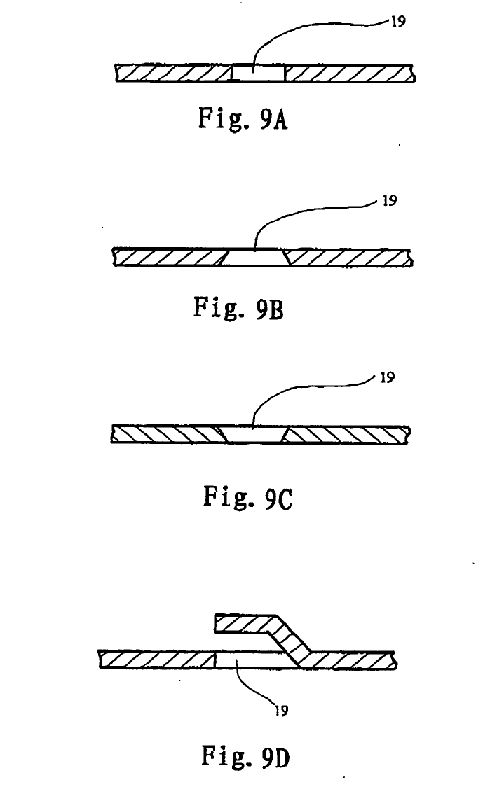

According to the present invention, perforations 19 formed on the tray with fixed valves can be shapes of a circular, and/or oval, and/or any other desired shape, can be through holes (in a shape of a cylinder, cone, or upside down cone, see FIGS. 9A-C) and/or partial blind holes (see FIG. 9D). The perforations 19 can be provided between two fixed valves with openings on both sides, between two fixed valves with an opening on only one side, or between one fixed valve with openings on both sides and one fixed valve with an opening on only one side.

Further, as shown in FIG. 3, on the tray 1 with fixed valves according to the present invention, in the central bubbling segment 14, the fixed valves 17 with openings on both sides are arranged in a row-to-row manner. Each row of the fixed valves 17 with openings on both sides is parallel to the weir 13 of the downcorner. One row of the fixed valves 17 with openings on both sides is staggered from another adjacent row of the fixed valves 17 with openings on both sides. The longitudinal centerline of the fixed valves 17 with openings on both sides is perpendicular to the weir 13 of the downcorner. On the other hand, in the two side bubbling segments 15, the fixed valves 17 with openings on both sides are arranged along the radii 43. The longitudinal centerline of the fixed valves 17 with openings on both sides is perpendicular to the radii 43 of the tower.

In fact, in the bubbling area 12, it is also possible to provide with some fixed valves 18 with an opening on only one side, and it is further possible to possible to simultaneously provide with several types of the fixed valves 17 with openings on both sides, several types of the fixed valves 18 with an opening on only one side, or both.

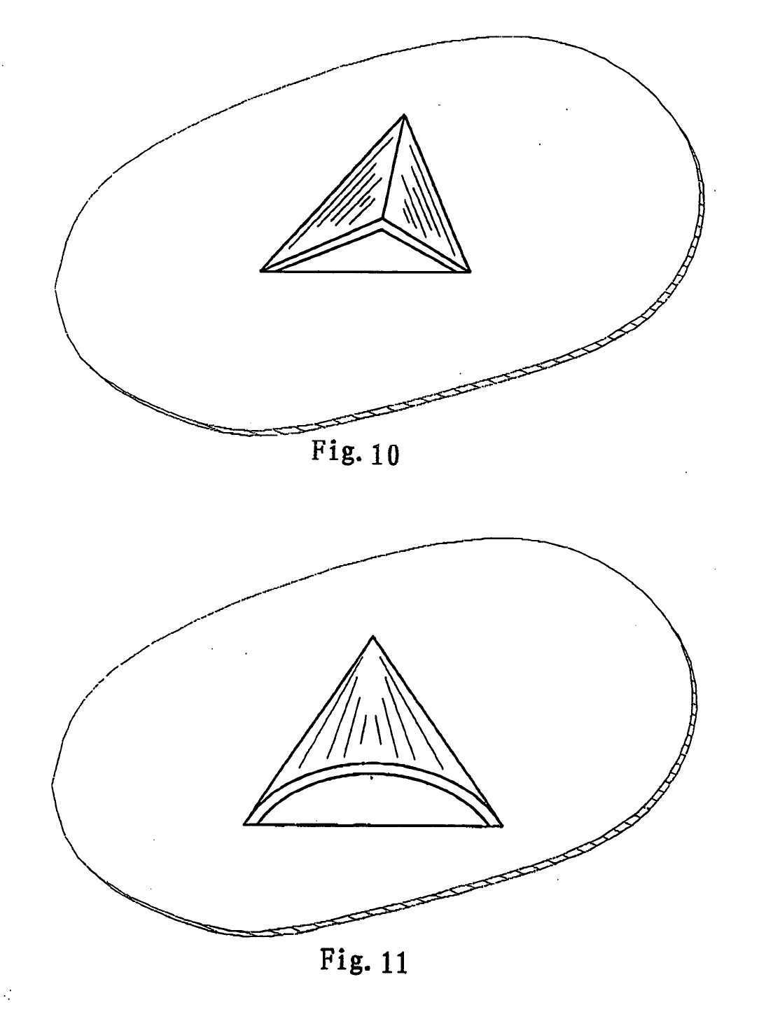

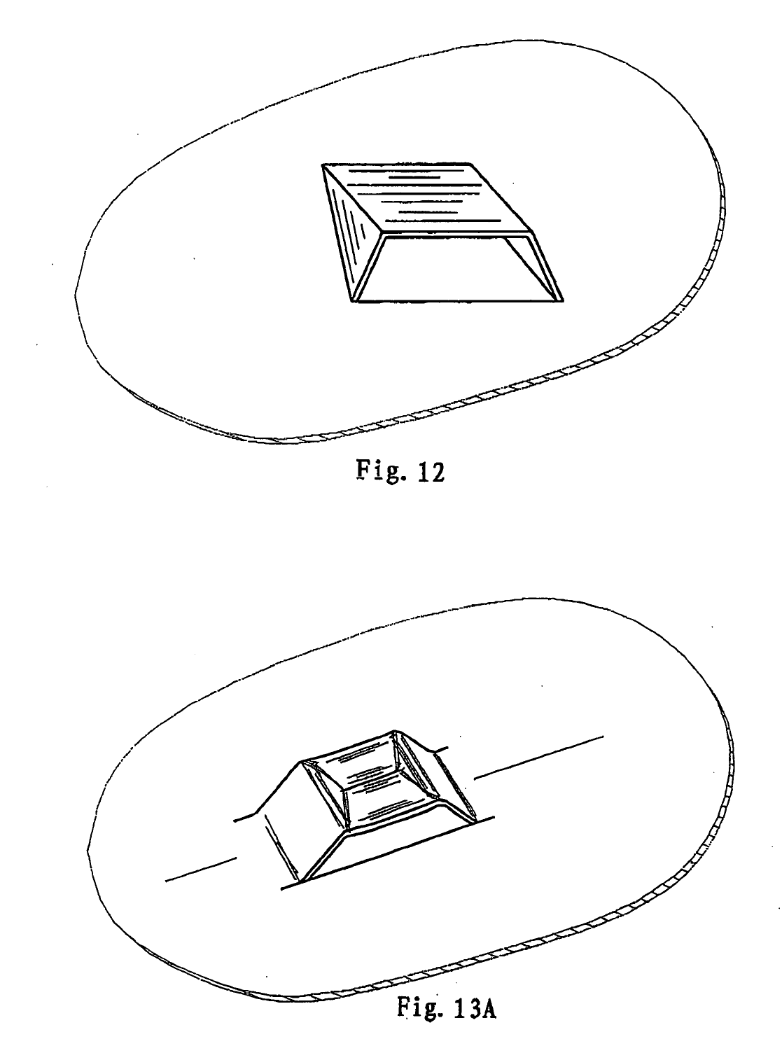

In some embodiments of the present invention, according to the shape of the opening 44 of the fixed valves 18 with an opening on only one side, there are an up-side-down V shaped fixed valve (see FIG. 10), arc shaped fixed valve (see FIG. 11), and trapezoid shaped fixed valve (see FIG. 12).

In one embodiment of the present invention, in the two side bubbling segments 15, near the wall 45 of the tower, some fixed valves 17 with openings on both sides can be replaced with the fixed valves 18 with an opening on only one side, and the opening 44 of the fixed valves 18 with an opening on only one side is parallel to the radii 43 of the tower.

According to one embodiment of the present invention, the tray with fixed valves has a tray deck 16, a plurality of fixed valves 17, a plurality of perforations 19 and a downcorner 5. The fixed valves 17 are directly formed by a punch process so as to be deflected from the tray deck 16. The perforations 19 are provided between the fixed valves 17 on the tray deck.

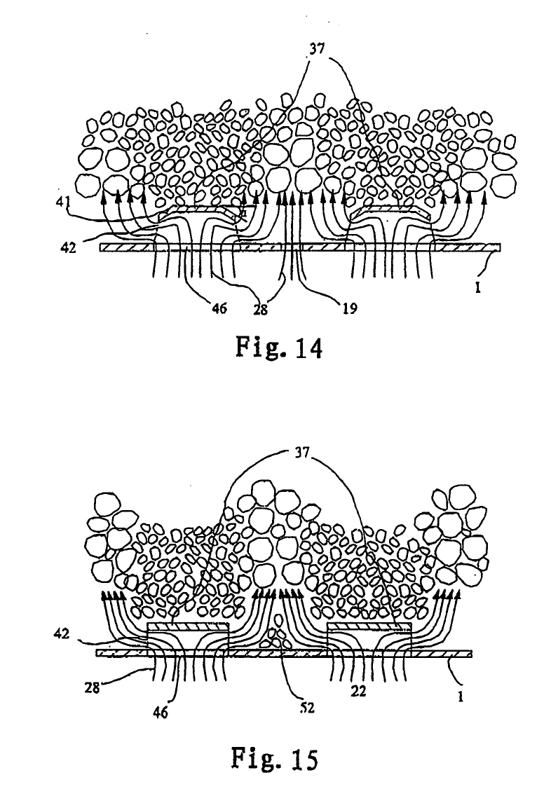

A fixed valve 17 of the tray is formed as a deflector overlying an aperture on the tray deck, including an upstream portion 25, a midportion 37, and a downstream portion 26. The midportion 37 is connected to the tray deck via the upstream portion 25 and the downstream portion 26. The midportion 37 has eaves 41 which are deflected downward with a degree of 10-60° (shown as a in FIG. 14), preferably 15-50°, for example 15°, 35°, 50°, etc. The edge of the eaves 41 is positioned 3˜10 mm above from the tray deck 16. While the fixed valves 17 are formed on the tray deck 16, the apertures 46 are also formed on the tray deck 16. An edge of the eaves 41, the upstream portion 25, the downstream portion 26, and an edge of aperture 46 are enclosed so as to form the opening 42 of the fixed valve. Each fixed valve 17 has two side openings 42. The midportion 37 of the fixed valve can be of a rectangular shape. For example, the length of the midportion 37 of the fixed valve can be as long as 20˜80 mm, while the width thereof can be as wide as 10˜40 mm. The upstream portion 25, the midportion 37, and the downstream portion 26 are all centrally located on the centerline 55 which is perpendicular to the weir 13 of the downcorner 5. The width of upstream portion 25 is equal to that of the downstream portion 26. The diameter of the perforations 19, which are arranged among the fixed valves 17 on the tray deck, is 8 mm, for example. Further, the perforations 19 can be arranged in such an array that every perforation is positioned on a vertex of a triangle, a square, a rhombus, or other desired shape. For example, the distance from the circumference of a perforation 19 to the edge of aperture 46 of an adjacent fixed valve is greater than or equal to 10 mm, while the distance between the two adjacent perforations 19 is two times of the diameter of the perforation 19 itself.

FIG. 14 illustrates the gas-liquid contact process on the tray deck according to the present invention. The jet 28 is forced to pass through the aperture 46 of the fixed valve in a upward direction, then is obstructed from the midportion 37 of the fixed valve, the eave 41 deflected downward, the upstream portion 25, the downstream portion 26, so is forced to change its flow direction, i.e., is ejected from the side opening 42 of the fixed valve and deflected toward to the tray deck 16, thus the jet 28 is blew onto the tray deck 16 at first and then goes up, so as to prevent from the face-to-face impinging occurred in prior art between any two adjacent fixed valves 17. Moreover, the jet 28 also upwardly goes through the perforations 19 and enters the bubbling liquid on the tray deck, so as to destroy any whirlpool 52 possibly existed in the two adjacent fixed valves 17.

Although the present invention has been described in detail together with some specific embodiments according to the present inventors' broad inventive concept, the above disclosure is not all of this invention, and those skilled in the art may have any hints from the illustrated embodiments and try to amend the technical solutions in every possible ways, which are all contained in the attached claims.

1. A gas-liquid contact tray with fixed valves for mass transfer, in which the fixed valve comprising an upstream portion, a midportion and a downstream portion is made by punch from the tray deck so as to form as a deflector, and the upstream portion and the downstream portion are integrated with the tray deck, characterized in that said midportion has a central plane portion and downward inclined margins.

2. A gas-liquid contact tray with fixed valves for mass transfer, in which the fixed valve comprising an upstream portion, a midportion and a downstream portion is made by punch from the tray deck so as to form as a deflector, and the upstream portion and the downstream portion are integrated with the tray deck, characterized in that said midportion is of an up-side-down V shape or an arc shape.

3. A gas-liquid contact tray with fixed valves for mass transfer, the upstream portion and the downstream portion of the fixed valve are made by punch from the tray deck, so as to be integrated with the tray deck, characterized in that the tray deck, the upstream portion and the downstream portion are enclosed to form only one opening on one side of the fixed valves, and the opening is of an up-side-down V shape, an arc shape, a trapezoid shape, a rectangle shape, or a square shape.

4. A gas-liquid contact tray with fixed valves for mass transfer, in which the fixed valve comprising an upstream portion and a downstream portion is made by punch from the tray deck, and the upstream portion and the downstream portion are integrated with the tray deck, characterized in that the tray deck is further provided with perforations which are arranged between the fixed valves adjacent in the liquid flow direction.

5. A gas-liquid contact tray with fixed valves for mass transfer, in which the fixed valve comprising an upstream portion and a downstream portion is made by punch from the tray deck, and the upstream portion and the downstream portion are integrated with the tray deck, characterized in that said fixed valves include the fixed valves with openings on both sides, and/or the fixed valves with an opening on only one side.

6. A gas-liquid contact tray with fixed valves for mass transfer, in which the fixed valve comprising an upstream portion, a midportion and a downstream portion is made by punch from the tray deck so as to form as a deflector, and the upstream portion and the downstream portion are integrated with the tray deck, characterized in that said midportion has a central plane portion and downward inclined margins, and the tray deck is further provided with perforations which are arranged between the fixed valves adjacent in the liquid flow direction.

7. A gas-liquid contact tray with fixed valves for mass transfer according to claim 1, characterized in that in the two side bubbling segments, the fixed valves with openings on both sides are arranged along the radii, and the longitudinal centerline of the fixed valves with openings on both sides is perpendicular to the radii of the tower.

8. A gas-liquid contact tray with fixed valves for mass transfer according to claim 1, characterized in that in the two side bubbling segments, near the wall of the tower, there are provided with the fixed valves with an opening on only one side, and the opening of the fixed valves with an opening on only one side is parallel to the radii of the tower.

9. A gas-liquid contact tray with fixed valves for mass transfer according to claim 4, characterized in that said perforations are of a rectangle, trapezoid, circular, oval, square, triangle, or polygon shape.

10. A gas-liquid contact tray with fixed valves for mass transfer according to claim 4, characterized in that said perforations are through holes and/or partial blind holes.
